(19) United States
(12) Patent Application Publication
(10) Pub. No.: US 2016/0201692 A1
(43) Pub. Date: Jul. 14, 2016

(54) FUEL PUMP

(71) Applicant: DENSO CORPORATION, Kariya-city, Aichi-pref. (JP)

(72) Inventors: Masaya OOTAKE, Kariya-city (JP); Hiromi SAKAI, Kariya-city (JP); Kiyoshi NAGATA, Kariya-city (JP)

(21) Appl. No.: 14/912,495

(22) PCT Filed: Sep. 3, 2014
(86) PCT No.: PCT/JP2014/004532

§ 371 Date: Feb. 17, 2016

(30) Foreign Application Priority Data
Sep. 17, 2013 (JP) 2013-191599

(51) Int. Cl. F04D 29/66; F04D 3/00; F04D 29/52; F04D 29/043; F04D 29/046; F04D 29/18; F02M 59/00; F04D 13/06

(52) U.S. Cl. CPC F04D 29/669; F02M 59/00; F04D 3/005; F04D 13/06; F04D 29/043; F04D 29/046; F04D 29/181; F04D 29/528

(57) ABSTRACT

A bearing receiving portion includes a receiving space that receives a bearing, which rotatably supports an end portion of a shaft. The bearing receiving portion includes an intermediate inner diameter portion, which receives the end portion of the shaft, and a small inner diameter portion, which includes a column shape space having an inner diameter that is smaller than an outer diameter of the end portion. Fuel in an inside of a housing flows into or flows out relative to the receiving space. When the shaft is moved toward an upside, the fuel, which is accumulated in a space formed by a bottom wall, an inner wall and an end surface, functions as a damper to reduce a relative moving speed of the shaft relative to the bearing receiving portion.

### CROSS REFERENCE TO RELATED APPLICATION

This application is based on and incorporates herein by reference Japanese Patent Application No. 2013-191599 filed on Sep. 17, 2013.

### TECHNICAL FIELD

The present disclosure relates to a fuel pump.

### BACKGROUND ART

There is known a fuel pump that includes an impeller, which is rotatable in a pump chamber, and a motor, which can drive the impeller to rotate the impeller. The fuel pump pumps fuel of a fuel tank to an internal combustion engine through rotation of the impeller. The Patent Literature 1 recites a fuel pump that has a motor, which includes a stator and a rotor rotatably supported on a radially inner side of the stator. In this fuel pump, an impeller is rotated through rotation of the rotor.

In the fuel pump of the Patent Literature 1, a shaft, which is rotated integrally with the rotor, is rotatably supported by two bearings that are installed at two end parts, respectively, of the fuel pump. One of the bearings is placed at a location that is adjacent to the impeller, which is joined to one end portion of the shaft. The other one of the bearings, which supports the other end portion of the shaft, is supported by a cover end that is installed to an end portion of a housing, which receives the stator and the rotor. When the shaft is vibrated in the fuel pump by vibrations of a vehicle, which has the fuel pump, the end portion of the shaft collides against the cover end to generate a collision sound. When a relative moving speed of the shaft relative to the cover end is high, the collision sound becomes large. Therefore, when the vibrations of the fuel pump are increased, the noise generated by the fuel pump is increased.

### CITATION LIST

### Patent Literature

PATENT LITERATURE 1: JP2011-030328A (corresponding to US2011/0020154A1)

### SUMMARY OF INVENTION

An objective of the present disclosure is to provide a fuel pump that reduces a noise generated by vibrations.

In order to achieve the above objective, according to the present disclosure, there is provided a fuel pump including: a housing that is configured into a tubular form; a pump cover that includes a suction port, through which fuel is drawn into an inside of the housing, wherein the pump cover is installed to one end portion of the housing; a cover end that includes a discharge port, through which the fuel is discharged to an outside of the housing, wherein the cover end is installed to another end portion of the housing; a stator; a rotor; a shaft that rotates integrally with the rotor; a bearing that is supported by the cover end and rotatably supports an end portion of the shaft, which is located on the cover end side; a bearing receiving portion that is formed in a portion of the cover end located in the inside of the housing, wherein the bearing receiving portion has a receiving space, which receives the bearing; and an impeller. The bearing receiving portion includes: a first tubular portion that is configured into a tubular form and receives the end portion of the shaft, which is located on the cover end side; and a second tubular portion that is configured into a tubular form having a bottom and connects between the first tubular portion and the cover end, wherein the fuel, which is present in the housing, flows into or flows out of the receiving space; and an inner diameter of the receiving space in the second tubular portion is smaller than an outer diameter of the end portion of the shaft, which is located on the cover end side.

In the fuel pump of the present disclosure, the end portion of the shaft, which is located on the cover end side, is received in the receiving space of the first tubular portion of the bearing receiving portion. A portion of the fuel in the housing is accumulated in the receiving space of the second tubular portion formed between the first tubular portion and the cover end. That is, the fuel, which is accumulated in the second tubular portion, is located between the end portion of the shaft and the cover end. When the shaft is moved toward the cover end due to, for example, vibrations of the fuel pump, the fuel, which is accumulated in the receiving space of the second tubular portion, is moderately outputted into the inside of the housing and thereby functions as a damper that reduces the relative moving speed of the shaft relative to the cover end. In this way, the collision between the end portion of the shaft and the cover end at the relatively high speed is limited. Thus, the noise, which is generated by the collision between the shaft and the cover end, can be reduced.

### BRIEF DESCRIPTION OF DRAWINGS

FIG. 1 is a cross-sectional view of a fuel pump according to an embodiment of the present disclosure.

FIG. 2 is a partial enlarged view of an area II in FIG. 1.

FIG. 3 is a cross-sectional view for describing an operation of the fuel pump of FIG. 1.

FIG. 4 is a cross-sectional view for describing the operation of the fuel pump of FIG. 1 and is different from FIG. 3.

### DESCRIPTION OF EMBODIMENTS

Hereinafter, an embodiment of the present disclosure will be described with reference to the accompanying drawings.

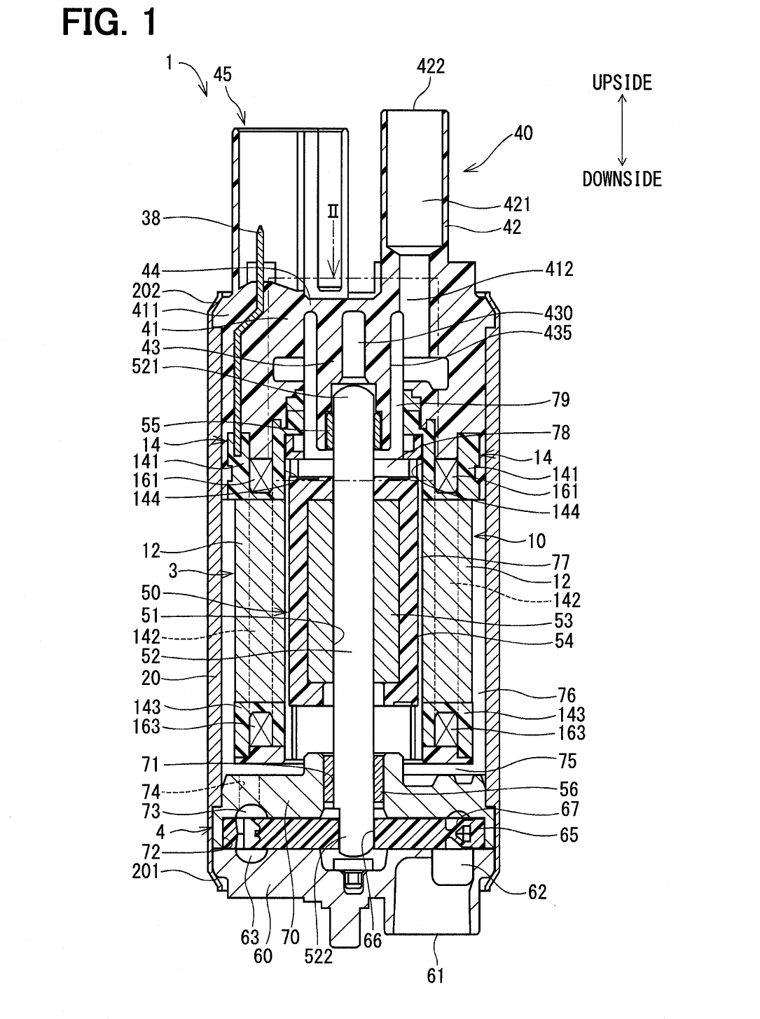

A fuel pump according to the embodiment of the present disclosure will be described with reference to FIGS. 1 to 4.

The fuel pump 1 includes a motor arrangement 3, a pump arrangement 4, a housing 20, a pump cover 60, a cover end 40 and a bearing receiving portion 43. In the fuel pump 1, the motor arrangement 3 and the pump arrangement 4 are received in a space, which is formed by the housing 20, the pump cover 60 and the cover end 40. The fuel pump 1 draws fuel from a fuel tank (not shown) through a suction port 61, which is indicated at a lower side of FIG. 1, and the fuel pump 1 discharges the drawn fuel toward an internal combustion engine through a discharge port 422, which is indicated at an upper side in FIG. 1. In FIGS. 1 to 4, the upper side will be referred to as “an upside”, and the lower side will be referred to as “a downside.”

The housing 20 is configured into a cylindrical tubular form and is made of metal (e.g., iron).

The pump cover 60 closes an end portion 201 of the housing 20, which is located on a side where the suction port 61 is placed. The pump cover 60 is fixed in an inside of the housing 20 by inwardly crimping a peripheral edge of the end portion 201 of the housing 20 against the pump cover 60, and thereby removal of the pump cover 60 from the housing 20 in an axial direction is limited.

The cover end 40 is made of resin and closes an end portion 202 of the housing 20 located on a side where the discharge port 422 is placed. The cover end 40 includes a base portion 41 and a discharge portion 42.

The base portion 41 is placed to close the end portion 202 of the housing 20. The base portion 41 is connected to an upside portion of a stator 10 of the motor arrangement 3 and is formed to be integrated with the stator 10. A peripheral edge of the end portion 202 of the housing 20 is crimped against a radially outer side edge part 411 of the base portion 41. In this way, the base portion 41 is fixed in the inside of the housing 20, so that removal of the base portion 41 from the housing 20 in the axial direction is limited. A fuel passage 412 is formed in the base portion 41 at a location, which is displaced from a center of the base portion 41. The fuel passage 412 is communicated with a fuel passage 421 of the discharge portion 42. The discharge portion 42 is connected to a part of the base portion 41 located at the outside of the housing 20.

The discharge portion 42 is configured into a generally tubular form and extends to the outside of the housing 20 at the location, which is displaced from the center of the base portion 41. The discharge portion 42 includes the fuel passage 421 and the discharge port 422. The fuel at the inside of the housing 20 flows through the fuel passage 421.

The bearing receiving portion 43 is configured into a generally tubular form having a bottom. The bearing receiving portion 43 extends from a generally center part of the base portion 41 toward the interior of the housing 20. The bearing receiving portion 43 includes a receiving space (blind hole) 430. The receiving space 430 receives an end portion 521 of the shaft 52 and a bearing 55, which rotatably supports the end portion 521 of the shaft 52. The bearing 55 is a bearing formed by a cylindrical body that is made of metal. The bearing receiving portion 43 includes a large inner diameter portion 431, an intermediate inner diameter portion 432, which serves as “a first tubular portion”, and a small inner diameter portion 433, which serves as “a second tubular portion.” The large inner diameter portion 431, the intermediate inner diameter portion 432 and the small inner diameter portion 433 are coaxial with the rotational axis O of the shaft 52.

The large inner diameter portion 431 is placed at a side of the bearing receiving portion 43 where the motor arrangement 3 is placed. The bearing 55 is securely press fitted into the large inner diameter portion 431. The shaft 52 is slidably supported by an inner wall 55a, which is configured into a cylindrical form, of the bearing 55. A plurality of flow passages (fuel flow passages) 436, through which the fuel can flow, is arranged one after another in a circumferential direction at a location between the inner wall 425 of the large inner diameter portion 431 and an outer wall 55b, which is configured into a cylindrical form, of the bearing 55. Specifically, a plurality of grooves 436a, which extend in the axial direction of the rotational axis O of the shaft 52, is formed in the inner wall 425 of the large inner diameter portion 431, to which the outer wall 55b of the bearing 55 contacts in the radial direction, and these grooves 436a are arranged one after another at generally equal intervals in the circumferential direction. Each groove 436a forms the flow passage 436, which communicates between the receiving space 430 of the intermediate inner diameter portion 432 and the outside of the bearing receiving portion 43.

The intermediate inner diameter portion 432 includes a column shape space, which is placed in an inside of the intermediate inner diameter portion 432 and has an inner diameter that is smaller than an inner diameter of the receiving space 430 in the large inner diameter portion 431. The column shape space, which is located in the inside of the intermediate inner diameter portion 432, forms a portion of the receiving space 430. The intermediate inner diameter portion 432 connects between the large inner diameter portion 431 and the small inner diameter portion 433. The end portion 521 of the shaft 52 is placed in the inside of the intermediate inner diameter portion 432.

The small inner diameter portion 433 has a column shape space, which is placed in the inside of the small inner diameter portion 433 and has an inner diameter that is smaller than the inner diameter of the receiving space 430 of the intermediate inner diameter portion 432. Furthermore, the small inner diameter portion 433 is formed such that the inner diameter of the receiving space 430 of the small inner diameter portion 433 is smaller than the outer diameter of the end portion 521 of the shaft 52. The column shape space, which is located in the inside of the small inner diameter portion 433, forms a portion of the receiving space 430. The small inner diameter portion 433 is connected to an end part of the intermediate inner diameter portion 432, which is opposite from an end part of the intermediate inner diameter portion 432 connected to the large inner diameter portion 431. The small inner diameter portion 433 forms the receiving space 430 and includes a bottom wall 434, which extends generally perpendicular to the rotational axis O of the shaft 52.

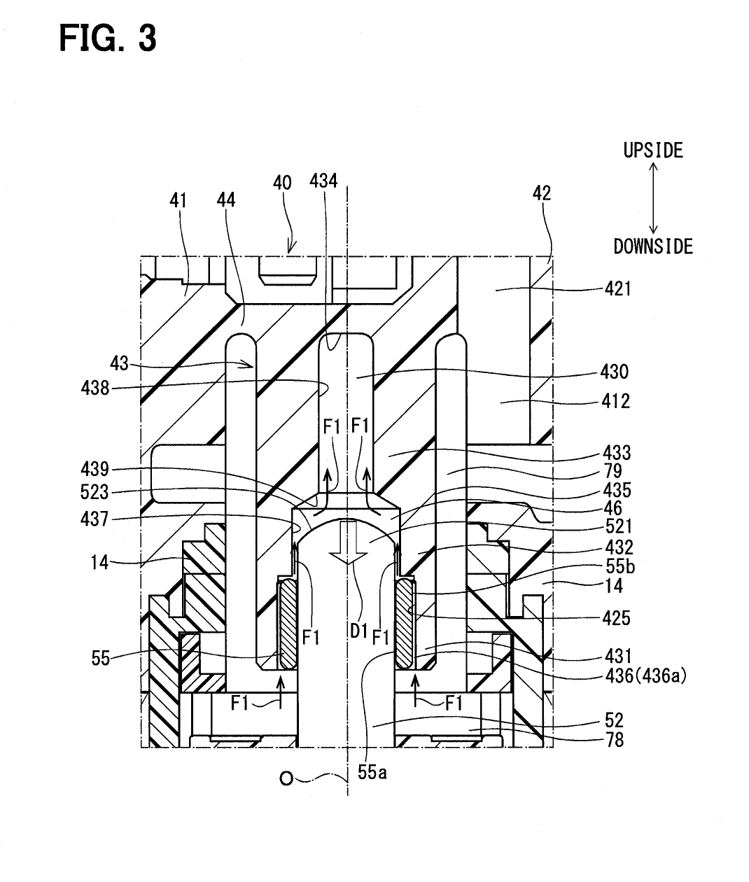

An inner wall 437 serves as a first tubular portion inner wall and forms the receiving space 430 in the inside of the intermediate inner diameter portion 432. An inner wall 438 serves as a second tubular portion inner wall and forms the receiving space 430 in the small inner diameter portion 433. The inner wall 437 and the inner wall 438 are connected to each other through a connection wall 439, which serves as a tilted wall. The connection wall 439 is formed to be tilted relative to the rotational axis O of the shaft 52 and extends along an upside end surface 523 (a shape of the end surface 523) of the end portion 521 of the shaft 52. Specifically, the end surface 523 of the end portion 521 of the shaft 52 is configured into a semi-spherical surface that is tapered toward the small inner diameter portion 433. An inner peripheral surface of the connection wall 439 forms a tapered surface that is tapered from the inner wall 437 of the intermediate inner diameter portion 432 toward the inner wall 438 of the small inner diameter portion 433. Here, it should be noted that although a cross section of the connection wall 439 shown in FIG. 3 is linearly tapered, the cross section of the connection wall 439 may be tapered in a form of a curved surface in conformity with the shape of the end surface 523, which is in the form of the semispherical surface, of the end portion 521 of the shaft 52.

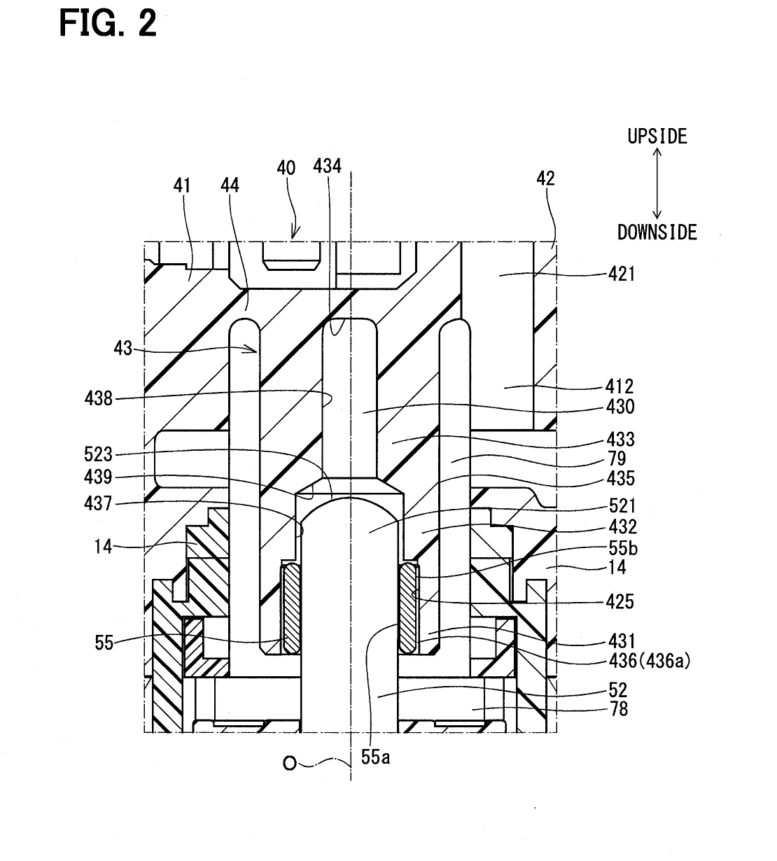

A connecting portion 44 is a portion that connects between the base portion 41 and the bearing receiving portion 43 on a radially outer side of the small inner diameter portion 433 of the bearing receiving portion 43. As shown in FIG. 2, a thickness of the connecting portion 44, which is measured in the axial direction of the rotational axis O of the shaft 52, is smaller than a thickness of the base portion 41 and a thickness of the bearing receiving portion 43 and is set to be a thickness that can withstand a pressure of the fuel in the housing 20.

The motor arrangement 3 includes the stator 10, a rotor 50 and the shaft 52. The motor arrangement 3 is a brushless motor. When an electric power is supplied to the stator 10, a magnetic field is generated at the stator 10. Thereby, the rotor 50 is rotated together with the shaft 52.

The stator 10 is configured into a cylindrical tubular form and is received at a radially outer side location in the inside of the housing 20. The stator 10 includes six cores 12, six bobbins, six windings and the three power supply terminals. The stator 10 is integrally formed through insert molding of these components with resin.

Each core 12 is formed by stacking a plurality of plates, which are made of a magnetic material (e.g., iron). The cores 12 are arranged one after another in a circumferential direction and are placed at a location where the cores 12 oppose a magnet 54 of the rotor 50.

The bobbins 14 are made of a resin material. At the time of manufacturing, the cores 12 are inserted into and integrated with the bobbins 14, respectively. Each bobbin 14 includes an upper end portion 141, an insert portion 142 and a lower end portion 143. The upper end portion 141 is formed on the discharge port 422 side. Each core 12 is inserted into the insert portion 142 of the corresponding bobbin 14. The lower end portion 143 is formed on the suction port 61 side.

Each of the windings is, for example, a copper wire that has an outer surface coated with a dielectric film. Each winding is wound around the corresponding bobbin 14, into which the core 12 is inserted, to form one coil. Each winding includes an upper end winding portion 161, an insert winding portion (not shown) and a lower end winding portion 163. The upper end winding portion 161 is wound around the upper end portion 141 of the corresponding bobbin 14. The insert winding portion is wound around the insert portion 142 of the bobbin 14. The lower end winding portion 163 is wound around the lower end portion 143 of the bobbin 14. Each of the windings is electrically connected to a corresponding one of a W-phase terminal 37, a V-phase terminal 38 and a U-phase terminal 39, which are the power supply terminals placed at the upside portion of the fuel pump 1.

The W-phase terminal 37, the V-phase terminal 38 and the U-phase terminal 39 are fixed to the base portion 41 of the cover end 40. The W-phase terminal 37, the V-phase terminal 38 and the U-phase terminal 39 receive a three-phase electric power from an electric power source device (not shown).

The rotor 50 is rotatably received on the inner side of the stator 10. The rotor 50 includes the magnet 54, which is placed to surround an iron core 53. The magnet 54 has N-poles and S-poles, which are alternately arranged one after another in the circumferential direction. In the present embodiment, the number of the N-poles is two, and the number of the S-poles is two.

The shaft 52 is securely press fitted into a shaft hole 51 of the rotor 50, which extends along a rotational axis of the rotor 50, and the shaft 52 is rotated integrally with the rotor 50.

Next, the structure of the pump arrangement 4 will be described.

The pump cover 60 includes the suction port 61, which is in a tubular form and opens toward the downside. A suction passage 62 is formed in an inside of the suction port 61 to extend through the pump cover 60 in the axial direction of the rotational axis O of the shaft 52.

A pump casing 70, which is configured into a generally circular plate form, is placed between the pump cover 60 and the stator 10. A through-hole 71 is formed in a center part of the pump casing 70 to extend through the pump casing 70 in a plate thickness direction of the pump casing 70. A bearing 56 is fitted into the through-hole 71. The bearing 56 rotatably supports an end portion 522 of the shaft 52, which is placed at a pump chamber 72 side. In this way, the rotor 50 and the shaft 52 are rotatable relative to the cover end 40 and the pump casing 70.

The impeller 65 is made of resin and is configured into a generally circular plate form. The impeller 65 is received in the pump chamber 72, which is formed between the pump cover 60 and the pump casing 70. The end portion of the shaft 52, which is located at the pump chamber 72 side, is configured into a D-shape that is formed by cutting a part of an outer wall of the end portion of the shaft 52. The end portion 522 of the shaft 52 is fitted into a corresponding hole 66, which is configured into a D-shape and is formed at the center part of the impeller 65. In this way, the impeller 65 is rotated in the pump chamber 72 through the rotation of the shaft 52.

A groove 63, which is communicated with the suction passage 62, is formed in the impeller 65 side surface of the pump cover 60. A groove 73 is formed in the impeller 65 side surface of the pump casing 70. A fuel passage 74, which extends through the pump casing 70 in the axial direction of the rotational axis O of the shaft 52, is communicated with the groove 73. The impeller 65 includes blades 67 at a location which corresponds to the groove 63 and the groove 73.

In the fuel pump 1, when the electric power is supplied to the windings of the motor arrangement 3, the impeller 65 is rotated along with the rotor 50 and the shaft 52. When the impeller 65 is rotated, the fuel in the fuel tank, which receives the fuel pump 1, is guided to the groove 63 through the suction port 61. The fuel, which is guided to the groove 63, is pressurized through the rotation of the impeller 65 and is guided to the groove 73. The pressurized fuel is guided to an intermediate chamber 75, which is formed between the pump casing 70 and the motor arrangement 3, through the fuel passage 74.

The fuel, which is guided to the intermediate chamber 75, is conducted through a fuel passage 77, which is formed between the rotor 50 and the stator 10, a fuel passage 78, which is formed between an outer wall of the shaft 52 and inner walls 144 of the bobbins 14, and a fuel passage 79, which is formed between the base portion 41 of the cover end 40 and an outer wall 435 of the bearing receiving portion 43. Furthermore, a portion of the fuel, which is guided to the intermediate chamber 75, is conducted through a fuel passage 76 that is formed between the housing 20 and the stator 10. The fuel, which has passed through the fuel passages 76, 77, 78, is guided into the fuel passage 412. The fuel, which is guided into the fuel passage 412, is discharged to the outside through the fuel passage 421 and the discharge port 422.

Furthermore, the fuel passage 78 is communicated with the receiving space 430 through the flow passages 436, which are formed between the bearing receiving portion 43 and the bearing 55. Therefore, when the fuel pump 1 is driven, the fuel is accumulated in the receiving space 430.

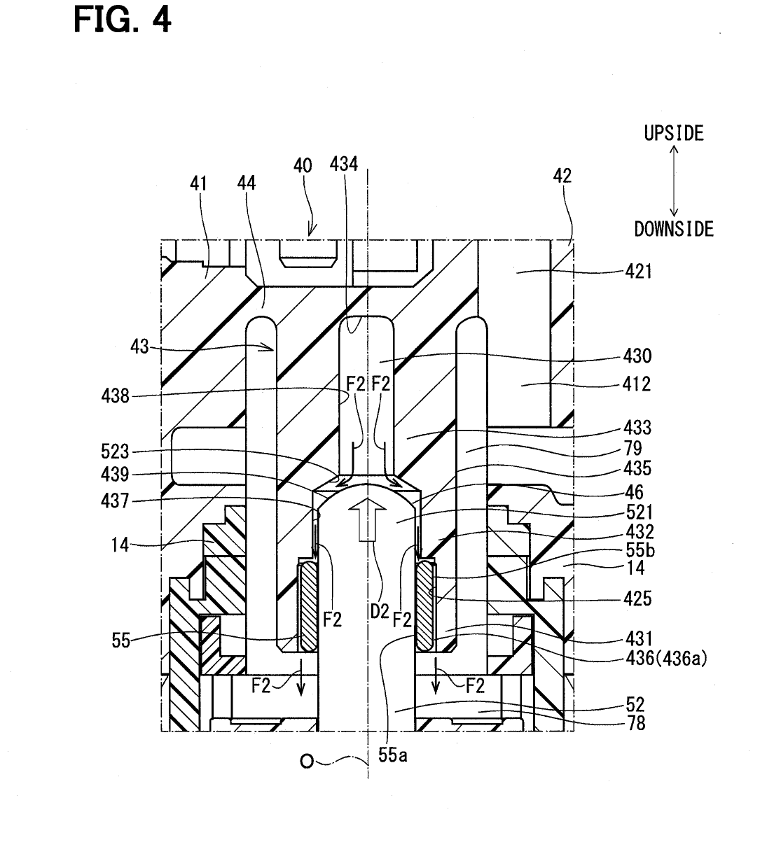

In the fuel pump 1 of the present embodiment, the shaft 52 is vibrated in the vertical direction by, for example, vibrations of a vehicle, which has the fuel pump 1. At this time, the shaft 52 collides against the bearing receiving portion 43. Here, the operation and the advantage of the present embodiment will be described based on a cross-sectional view of FIGS. 3 and 4, which indicate a positional relationship between the bearing receiving portion 43 of the cover end 40 and the end portion 521 of the shaft 52.

When the shaft 52 is moved in a direction of a blank arrow D1, the fuel flows into the space, which is formed by the bottom wall 434, the inner wall 438, the connection wall 439 and the end surface 523 of the shaft 52, through the flow passages 436, and a relatively narrow gap 46 that is formed between the connection wall 439 and the end surface 523 of the shaft 52, as indicated by solid arrows Fl in FIG. 3. In this way, the fuel is accumulated between the end surface 523 of the shaft 52 and the bottom wall 434.

In contrast, when the shaft 52 is moved in a direction of a blank arrow D2, the fuel, which is accumulated in the space formed by the bottom wall 434, the inner wall 438, the connection wall 439 and the end surface 523, is pushed into the fuel passage 78 by the end portion 521 of the shaft 52, as indicated by solid arrows F2 in FIG. 4. At this time, the fuel, which is accumulated in this space, flows out from this space into the fuel passage 78 through the gap 46. In this way, the fuel, which is accumulated in the space formed by the bottom wall 434, the inner wall 438, the connection wall 439 and the end surface 523, functions as a damper that slows down the moving speed of the shaft 52 in the direction of the blank arrow D2, so that the shaft 52 collides against the connection wall 439 at a relatively slow speed.

As discussed above, in the fuel pump 1 of the present embodiment, the fuel is conducted between the space, which is formed by the bottom wall 434, the inner wall 438, the connection wall 439 and the end surface 523, and the fuel passage 78 through the gap 46, so that the collision of the shaft 52 against the connection wall 439 at the relative high speed is limited. In this way, in the fuel pump 1, the collision sound between the shaft 52 and the bearing receiving portion 43 is reduced, and thereby the noise, which is generated at the time of driving the fuel pump 1, can be reduced.

Furthermore, the collision of the shaft 52 against the connection wall 439 at the relatively high speed is limited, so that an impact load, which is applied from the shaft 52 against the bearing receiving portion 43 can be reduced. Thus, a damage of the constituent components of the fuel pump 1, such as the cover end 40, by the collision can be limited.

Furthermore, the connection wall 439, against which the end portion 521 of the shaft 52 collides, is formed to extend along the end surface 523 of the end portion 521 of the shaft 52 on the upside. In this way, a length of the gap 46 in the flow direction of the fuel is increased, so that a flow restricting effect of the gap 46 is enhanced. Thus, the fuel, which is accumulated in the space formed by the bottom wall 434, the inner wall 438, the connection wall 439 and the end surface 523, functions as the further enhanced damper, and thereby the noise generated through the collision of the shaft 52 against the bearing receiving portion 43 can be further reduced.

### Other Embodiments

In the above embodiment, the connection wall 439 is tilted relative to the rotational axis O of the shaft 52 and extends along the end surface 523 of the end portion 523 of the shaft 52. However, the shape of the connection wall is not limited to the above described shape. The connection wall may be formed to extend in a perpendicular direction, which is perpendicular to the rotational axis of the shaft. Furthermore, the connection wall may be formed as a planar surface without extending along the end surface of the end portion of the shaft.

In the above embodiment, the grooves 436a, which extend in the axial direction of the rotational axis O of the shaft 52, are formed in the inner wall 425 of the large inner diameter portion 431. Instead of forming the grooves 436a in the inner wall 425 of the large inner diameter portion 431, a plurality of grooves, which extend in the axial direction of the rotational axis O of the shaft 52, may be formed in the outer wall 55b of the bearing 55. Furthermore, the number of the groove(s) formed in the inner wall 425 of the large inner diameter portion 431 or the outer wall 55b of the bearing 55 may be one.

Furthermore, instead of forming the grooves 436a in the inner wall 425 of the large inner diameter portion 431, it is possible to form at least one hole, which extends through the wall of the bearing receiving portion 43 (e.g., the wall of the intermediate inner diameter portion 432) in the radial direction and forms a flow passage (fuel flow passage) that communicates between the receiving space 430 and the outside of the bearing receiving portion 43.

Furthermore, in the above embodiment, the bearing 55, which is formed separately from the bearing receiving portion 43, is press fitted to the inner wall 425 of the large inner diameter portion 431. Alternatively, the bearing may be integrally resin molded with the bearing receiving portion 43. In such a case, a plurality of grooves, which extend in the axial direction of the rotational axis O of the shaft 52, may be formed in the inner wall of the bearing that is formed integrally and seamlessly with the bearing receiving portion 43 to form a plurality of flow passages (fuel flow passages), through which the fuel can flow.

The present disclosure is not limited to the above embodiments, and the above embodiments may be modified in various ways within the principle of the present disclosure.

1. A fuel pump comprising:
a housing that is configured into a tubular form;
a pump cover that includes a suction port, through which fuel is drawn into an inside of the housing, wherein the pump cover is installed to one end portion of the housing;
a cover end that includes a discharge port, through which the fuel is discharged to an outside of the housing, wherein the cover end is installed to another end portion of the housing;
a stator, around which a plurality of windings is wound, wherein the stator is configured into a tubular form and is received in the housing;
a rotor that is rotatably placed on a radially inner side of the stator;
a shaft that is coaxial with the rotor and rotates integrally with the rotor;
a bearing that is supported by the cover end and rotatably supports an end portion of the shaft, which is located on the cover end side;
a bearing receiving portion that is formed in a portion of the cover end located in the inside of the housing, wherein the bearing receiving portion has a receiving space, which receives the bearing; and
an impeller that is installed to an end portion of the shaft, which is located on the pump cover side, wherein when the impeller is rotated together with the shaft, the impeller pressurizes the fuel drawn through the suction port and discharge the pressurized fuel through the discharge port, wherein:
the bearing receiving portion includes:
a first tubular portion that is configured into a tubular form and receives the end portion of the shaft, which is located on the cover end side; and
a second tubular portion that is configured into a tubular form having a bottom and connects between the first tubular portion and the cover end, wherein the fuel, which is present in the housing, flows into or flows out of the receiving space; and
an inner diameter of the receiving space in the second tubular portion is smaller than an outer diameter of the end portion of the shaft, which is located on the cover end side.

2. The fuel pump according to claim 1, wherein a first tubular portion inner wall of the first tubular portion, which forms the receiving space, and a second tubular portion inner wall of the second tubular portion, which forms the receiving space, are connected with each other by a tilted wall, which is tilted relative to a rotational axis of the shaft.

3. The fuel pump according to claim 2, wherein the tilted wall is tapered from the first tubular portion inner wall toward the second tubular portion inner wall, and an end surface of the end portion of the shaft, which is located on the cover end side, is tapered toward the second tubular portion.

4. The fuel pump according to claim 1, wherein:
the bearing receiving portion includes a large inner diameter portion, which extends from an end part of the first tubular portion, which is opposite from the second tubular portion, toward the pump cover;
the large inner diameter portion is configured into a tubular form and has an inner diameter, which is larger than an inner diameter of the first tubular portion;
an outer wall of the bearing is supported by an inner wall of the large inner diameter portion; and
at least one fuel flow passage is formed between the inner wall of the large inner diameter portion and the outer wall of the bearing to communicate between the receiving space in the first tubular portion and an outside of the bearing receiving portion.
